(19) United States
(12) Patent Application Publication
(10) Pub. No.: US 2026/0169285 A1
(43) Pub. Date: Jun. 18, 2026

(54) DISPLAY APPARATUS INTEGRATING GAZE-TRACKING LIGHT EMITTERS IN DISPLAY MODULE

(71) Applicant: Varjo Technologies Oy, Helsinki (FI)

(72) Inventors: Kaj Saarinen, Turku (FI); Mikko Ollila, Tampere (FI); Perttu Keinänen, Turku (FI)

(73) Assignee: Varjo Technologies Oy, Helsinki (FI)

(21) Appl. No.: 18/985,836

(22) Filed: Dec. 18, 2024

(51) Int. Cl. G02B 27/00; G02B 27/01

(52) U.S. Cl. CPC G02B 27/0093; G02B 27/0172; G02B 2027/0112; G02B 2027/0138; G02B 2027/014

(57) ABSTRACT

A display apparatus including a display module with a display; and a gaze-tracking system with a plurality of light emitters and at least one light sensor, wherein the plurality of light emitters are arranged within a predefined region of an active area of the display module.

### TECHNICAL FIELD

The present disclosure relates to display apparatuses integrating gaze-tracking light emitters in display modules. Moreover, the present disclosure relates to methods for integrating gaze-tracking systems into display apparatuses comprising display modules.

### BACKGROUND

In recent years, a demand for gaze-tracking technology has significantly increased, driven by its applications in consumer electronics, extended-reality (XR) technologies, automotive interfaces, and similar. Typically, gaze tracking involves integrating gaze-tracking components, specifically, infrared light-emitting diodes (IR-LEDs) that emit infrared light for gaze-tracking purposes. These gaze-tracking components are precisely arranged in a display device to ensure they can perform gaze tracking without obstructing a user's view of a display of the display device.

Conventionally, existing solutions for incorporating the IR-LEDs for gaze-tracking involve arranging the IR-LEDs as separate physical elements around a display module of the display device or on the edges of an optical element (such as a lens) in the display device. While such an arrangement allows for functional gaze tracking of the user's eyes, it has several drawbacks. Firstly, such an arrangement increases overall physical dimensions of the display device, thereby making it bulkier. For example, in an XR device, where space is at a premium, said placement of the IR-LEDs can restrict the integration of other crucial components. Secondly, positioning the IR-LEDs as separate physical elements complicates an assembly process and can increase production costs due to a need for precise alignment and additional hardware to accommodate the gaze-tracking. This approach can also result in inconsistencies in IR illumination coverage across different devices, affecting the accuracy of the gaze tracking.

Therefore, in light of the foregoing discussion, there exists a need to overcome the aforementioned drawbacks.

### SUMMARY

The aim of the present disclosure is to provide a display apparatus and a method which facilitates accurately and reliably tracking a gaze of a user's eyes without obstructing a view of the user' eyes by way of arranging gaze-tracking light emitters within a predefined region of an active area of a display module, thereby enabling a compact design of the display apparatus without complicating an assembly process. The aim of the present disclosure is achieved by a display apparatus integrating gaze-tracking light emitters in a display module and a method for integrating a gaze-tracking system into such a display apparatus, as defined in the appended independent claims to which reference is made. Advantageous features are set out in the appended dependent claims.

Throughout the description and claims of this specification, the words “comprise”, “include”, “have”, and “contain” and variations of these words, for example, “comprising” and “comprises”, mean “including but not limited to”, and do not exclude other components, items, integers or steps not explicitly disclosed also to be present. Moreover, the singular encompasses the plural unless the context otherwise requires it. In particular, where the indefinite article is used, the specification is to be understood as contemplating plurality as well as singularity unless the context requires otherwise.

### BRIEF DESCRIPTION OF THE DRAWINGS

FIG. 1 illustrates a block diagram of an architecture of a display apparatus, in accordance with an embodiment of the present disclosure;

FIG. 2 illustrates steps of a method for integrating a gaze-tracking system into a display apparatus comprising a display module in accordance with an embodiment of the present disclosure;

FIG. 3A illustrates a conventional arrangement of a plurality of light emitters of a gaze-tracking system with respect to a display module;

FIGS. 3B and 3C illustrate exemplary arrangements of a plurality of light emitters with respect to the display module in accordance with an embodiment of the present disclosure;

FIG. 4 illustrates an exemplary arrangement of a plurality of light emitters in a backlight with respect to a liquid crystal display comprising at least one polariser, in accordance with an embodiment of the present disclosure;

FIG. 5 illustrates an exemplary arrangement of a plurality of light emitters in a backlight with respect to a liquid crystal display comprising a colour filter array in accordance with an embodiment of the present disclosure; and

FIG. 6 illustrates an exemplary arrangement of a plurality of light emitters in a backlight with respect to a liquid crystal display comprising a thin-film transistor array, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a display apparatus comprising:
a display module comprising a display; and
a gaze-tracking system comprising a plurality of light emitters and at least one light sensor, wherein the plurality of light emitters are arranged within a predefined region of an active area of the display module.

The present disclosure provides the aforementioned display apparatus, which accurately and reliably facilitates tracking a gaze of a user's eyes without obstructing a view of the user's eyes by way of arranging (gaze-tracking) light emitters within the predefined region of the active area of the display module, thereby enabling a compact design of the display apparatus without complicating an assembly process, as compared to the prior art where the plurality of light emitters are placed around the display module or around optical elements on an optical path between the display module and the user's eye. In addition to this, the arrangement of the plurality of light emitters within the predefined region ensures that the gaze-tracking system operates effectively without obstructing a primary function of the display (i.e., without obstructing a user's view of the display). Moreover, by arranging the plurality of light emitters within the predefined region of the active area of the display module, the plurality of light emitters may remain effectively invisible to the user whilst maintaining an optimal angle relative to the user's eye. Thus, the aforesaid arrangement of the plurality of light emitters enables accurate and reliable gaze tracking whilst achieving a compact design of the display apparatus without complicating an assembly process. It also reduces the manufacturing complexity of the display apparatus.

In a second aspect, the present disclosure provides method for integrating a gaze-tracking system into a display apparatus comprising a display module, the method comprising:
arranging a plurality of light emitters of the gaze-tracking system within a predefined region of an active area of the display module, the display module comprising a display; and
arranging at least one light sensor of the gaze-tracking system at one or more pre-defined locations in the display apparatus.

The present disclosure provides the aforementioned method, which facilitates manufacturing of the display apparatus by a way of arranging (gaze-tracking) light emitters within the predefined region of the active area of the display module, thereby enabling a compact design of the display apparatus without complicating an assembly process, as compared to the prior art. In addition to this, the method ensures that the plurality of light emitters are arranged within the predefined region of the active area of the display module during the manufacturing process. This arrangement facilitates precise placement of the plurality of light emitters to ensure that the gaze-tracking system operates effectively without obstructing a primary function of the display (i.e., without obstructing a user's view of the display). Moreover, by arranging the plurality of light emitters within the predefined region of the active area of the display module, the plurality of light emitters may remain effectively invisible to the user whilst maintaining an optimal angle relative to the user's eye. Thus, the aforesaid arrangement of the plurality of light emitters enables accurate and reliable gaze tracking whilst achieving a compact design of the display apparatus without complicating an assembly process. It also reduces the manufacturing complexity of the display apparatus. The method is simple, robust, supports real-time and reliable gaze tracking, and can be implemented with ease.

The term “display apparatus” refers to a specialized equipment that is capable of at least displaying images to a user. Optionally, the display apparatus is an extended-reality (XR) device, wherein the XR device is configured to present an XR environment to the user when the XR device, in operation, is worn by the user on his/her head. The XR could, for example, be implemented as an XR headset, a pair of XR glasses, and the like, which can be used to present a visual scene of the XR environment to the user. The term “extended-reality” encompasses virtual reality (VR), augmented reality (AR), mixed reality (MR), and the like.

Throughout the present disclosure, the term “display module” refers to a component comprising one or more elements (for example, such as the display and the gaze-tracking system) of the display apparatus. Optionally, the display module further comprises a display driver. Optionally, the display module further comprises at least one exit optical element. The aforesaid optional components of the display module are well-known in the art.

Throughout the present disclosure, the term “display” refers to a component which display images by way of emanating light. The display may comprise one or more layers, for example, a backlight layer, an array of pixels, and the like, in order to achieve brightness, colour, resolution, and the like of the images. It will be appreciated that the display module comprises the display as a core element of the display apparatus and integrates it into an overall design of the display apparatus. The display module enables integration of additional elements, such as the gaze-tracking system or similar, in the display apparatus whilst ensuring that the visual quality of the display remains unaffected.

Optionally, the display is one of: a liquid crystal display (LCD), a light emitting diode (LED)-based display. In this regard, the term “liquid crystal display” refers to a display that utilises liquid crystal molecules to modulate light to produce images. Optionally, the LCD is a light-emitting diode (LED)-backlit LCD. Moreover, the term “light emitting diode-based display” refers to a display that uses LEDs either as individual pixels (such as in micro-LED displays) or as a backlight source (such as in LED-backlit LCDs) to produce images. Optionally, the LED-based display is one of: a direct-view LED display, a mini-LED display, a micro-LED display, a quantum dot LED display, an organic LED (OLED) display, an active-matrix OLED (AMOLED) display, a flexible OLED display. It will be appreciated that the use of the LCD enables precise modulation of the light, offering high-quality image formation with vibrant colours and sharp contrasts. It will also be appreciated that the use of the LED-based display offers significant benefits in terms of brightness, energy efficiency, extended lifespan, and similar. A technical effect of implementing the display as one of: the LCD, the LED-based display, is that it enables high-quality rendering of images with enhanced brightness, colour accuracy, and energy efficiency while also extending the overall operational lifespan of the display apparatus.

Throughout the present disclosure, the term “gaze-tracking system” refers to specialized equipment for detecting and/or following a gaze of a given eye of the user. The gaze-tracking system is used in the display apparatus to track the gaze of the given eye of the user via non-invasive techniques. It will be appreciated that the gaze-tracking system could be arranged in the display apparatus in a manner that does not cause any obstruction in the user's view.

Throughout the present disclosure, the term “light emitter” refers to a component that, in operation, emits light. It will be appreciated that when the plurality of light emitters are arranged within the predefined region of the active area of the display module, the plurality of emitters are arranged in a manner that the plurality of emitters face the user's eye when the display apparatus, in operation, is worn by the user on his/her head. In this regard, a given emitter may be controlled (optionally, by at least one processor of the display apparatus) to emit the light towards the user's eye to illuminate the user's eye. During illumination of the user's eye by the given emitter, light emitted by the given emitter is reflected from the surface of the user's eye. The given emitter may be switched on to be illuminated, for example, using a control signal that is generated by the at least one processor. Examples of the plurality of light emitters may include, but are not limited to, infrared (IR) light-emitting diodes (LEDs), micro-LEDs, visible LEDs, laser diodes, organic OLEDs, and semiconductor lasers.

Further, the term “light sensor” refers to a component that, in operation, senses the light that is reflected off the surface of the user's eyes. In one instance, the at least one light sensor is arranged on or integrated within the gaze-tracking system in such a manner that the at least one light sensor is able to directly receive the light that is reflected from (the surface of) the eyes of the user. Moreover, the at least one light sensor converts captured light data into electronic signals, which are then processed to determine a position and an orientation of the eyes of the user with respect to at least one glint (formed due to a reflection of the light off an ocular surface of the eye). Such an operation of the gaze-tracking system is well-known in the art. Examples of the at least one light sensor may include, but are not limited to, a photodiode, an IR camera, a charge-coupled device (CCD) sensor, and a complementary metal-oxide-semiconductor (CMOS) sensor. It is to be understood that the at least one light sensor may be selected based on a type of a light emitter that is employed for emitting the light towards the user's eyes.

Throughout the present disclosure, the term “predefined region” of the active area of the display module refers to a region within the display module where the plurality of light emitters are arranged. Further, the term “active area” refers to a portion of the display module that is capable of producing visual output (namely, displaying the images to the user) when the display apparatus is in operation. Notably, the active area encompasses an entire portion of the display module capable of producing the visual output, regardless of how much portion of the active area is actually utilised or visible to the user.

Beneficially, arranging the plurality of light emitters within the predefined region of the active area of the display module allows for a compact design of the display module (and the display apparatus also), as compared to the prior art where the plurality of light emitters are placed around the display module or around optical elements on an optical path between the display module and the user's eye. In addition to this, the arrangement of the plurality of light emitters within the predefined region ensures that the gaze-tracking system operates effectively without obstructing a primary function of the display (i.e., without obstructing a user's view of the display), provided that certain design requirements are met. These requirements may include selecting appropriate positions within the predefined region that align with non-critical areas of the active area of the display and ensuring that the integration of the plurality of light emitters does not interfere with the display's visual output or the user experience. Moreover, by arranging the plurality of light emitters within the predefined region of the active area of the display module, the plurality of light emitters may remain effectively invisible to the user whilst maintaining an optimal angle relative to the user's eye. Thus, the aforesaid arrangement of the plurality of light emitters enables accurate and reliable gaze tracking whilst achieving a compact design of the display apparatus without complicating an assembly process. It also reduces the manufacturing complexity of the display apparatus, by integrating the plurality of light emitters within the predefined region of the active area of the display module, thereby eliminating the need for additional components or external arrangements, such as separate mounts or housings for the plurality of light emitters. This integration streamlines the assembly process, minimizes number of discrete parts, and avoids the alignment challenges typically associated with external positioning of the plurality of light emitters relative to the display module as in case of prior art. It will be appreciated that this may also enable manufacturers to adapt the gaze-tracking system to a range of display devices with different display screen sizes or display configurations without compromising performance.

Optionally, the predefined region of the active area of the display module is at least one of: an inactive region of the display, an occluded region of the display that would be invisible to a user of the display apparatus, a peripheral region of the display, an entirety of the display, a backlight of the display module. In this regard, the term “inactive region” of the display refers to a portion of the display that does not perform a function of rendering the visual output. This region may include areas such as display borders, edges, or other non-active sections that are electrically or functionally non-operational in generating/displaying images. It will be appreciated that when the plurality of light emitters are arranged in the inactive region of the display, it can be ensured that the plurality of light emitters do not interfere with or obstruct the visual output rendered by the active area of the display module. Additionally, such an arrangement provides an efficient use of available space within the display module.

Moreover, the term “occluded region” of the display refers to a portion of the display that is covered or concealed by structural elements (such as a bezel, a frame, an overlay, or similar) and is invisible to the user during an operation of the display apparatus. In the display apparatus, the arrangement of the plurality of light emitters within the occluded region is advantageous as it enables a use of an unused space in the display without affecting the visual output. It will be appreciated that arranging the plurality of light emitters in said region ensures an operation of the plurality of light emitters for gaze tracking do not interfere with the user's view. Further, the term “peripheral region” of the display refers to a boundary region of the display that surrounds the active area of the display module. It will be appreciated that the arrangement of the plurality of light emitters in the peripheral region enables an efficient utilization of space without obstructing the visual output shown to the user. Moreover, the term “entirety of the display” encompasses both a functional area (such as a content-rendering area) and a non-functional region (such as inactive or peripheral areas). An arrangement of the plurality of light emitters across the entirety of the display module ensures that the light can be emitted uniformly across a field of view the display, enhancing the effectiveness of the gaze tracking and providing flexibility in arranging light emitters. This arrangement maximises an available space within the display module for the arrangement of the plurality of light emitters while ensuring that their operation does not interfere with the visual output. Further, the term “backlight” refers to a light-emitting element that is capable of illuminating the display by producing white light. The backlight is well-known in the art. The plurality of light emitters can be arranged in the backlight of the display module to ensure that the plurality of light emitters remain unnoticeable to the user and do not interfere with the primary function of the display. It will be appreciated that the backlight source could include a laser, a projector, other beam-based sources, and the like.

Optionally, the plurality of light emitters comprise at least two of: an infrared light emitter, a visible light emitter. In this regard, the IR light emitter generates IR light, typically within a wavelength range of 700 nanometres to 1 millimetre, which is outside a visible spectrum. A plurality of IR light emitters may be arranged within the predefined region of the active area of the display module to remain unobtrusive while ensuring effective gaze tracking. A technical benefit of using the IR light emitter is that it enables accurate gaze-tracking without causing any visible distraction to the user, thereby maintaining a seamless viewing experience for the user. In other words, the emitted light of an IR wavelength or a near-IR wavelength is invisible (or imperceptible) to the human eye, thereby reducing unwanted distraction when such light is incident upon the user's eye. Moreover, the visible light emitter generates light within a visible spectrum range. In the display apparatus, the visible light emitter can serve multiple purposes, for example, such as providing visual cues or feedback to the user, illuminating specific areas of the display, or enhancing interaction of the user with the gaze-tracking system.

Optionally, light emitted by the plurality of light emitters is incident within an angular range of 0 degrees to 45 degrees relative to a surface normal of an eye of a user when the display apparatus is in use. In this regard, the term “surface normal” refers to a line that is perpendicular to an outermost layer of a given eye (such as a corneal surface of the given) at a point where the light is incident. The surface normal of the eye defines a reference axis for measuring angles of light incidence and reflection, ensuring a precise alignment of the light directed towards the eye in relation to the geometry of the eye. The light emitted from the plurality of light emitters may incident at an angle which lies in a range from 0, 1, 2, 3, 5, 7, 10, 15, 20, 25 or 30 degrees up to 4, 11, 17, 23, 28, 32, 36, 39, or 45 degrees. It will be appreciated when the display apparatus is in use; a technical benefit of emitting the light within the angular range of 0 degrees to 45 degrees is that it ensures an efficient reflection of the light from an ocular surface of the user's eyes, thereby minimizing a possibility of light scattering or light distortion, which is essential for accurate gaze-tracking measurements. Moreover, said angular range ensures a comfortable viewing experience for the user by preventing excessive brightness or discomfort, as the light emitted by the plurality of light emitters is incident at optimal angles for both gaze-tracking performance and user comfort.

Optionally, the at least one light sensor comprises at least one of: an infrared camera, a visible light camera, a multispectral camera, light field sensors, infrared light sensors, visible-light sensors. Optionally, when the at least one light sensor comprises the IR camera, the plurality of light emitters would comprise at least two IR light emitters. The at least two IR light emitters are employed to emit IR light towards the user's eye, while the at least one IR camera is employed to determine a position of a pupil of the user's eye with respect to at least one glint (formed due to a reflection of the IR light off an ocular surface of the eye). Optionally, when the at least one light sensor comprises the visible light camera, the plurality of light emitters would comprise at least two visible light emitters. The at least two visible light emitters are employed to emit visible light towards the user's eye, while the at least one visible light camera is employed to determine a position of a pupil of the user's eye with respect to at least one glint (formed due to a reflection of the visible light off an ocular surface of the user's eye). Optionally, when the at least one light sensor comprises the multispectral camera, a spectral range of the multispectral camera may span across a visible light spectrum and an IR light spectrum. Thus, the multispectral camera can capture glints formed by both the IR light and the visible light. Optionally, when the at least one light sensor comprises the light field sensors, the light field sensors are employed to capture a wavefront of light reflected off an ocular surface of the user's eye, wherein the wavefront is indicative of a geometry of a part of the ocular surface that reflected the light. After capturing the wavefront and reconstructing the geometry of the part of the ocular surface, the direction of the user's gaze is estimated based on a shape and an orientation of the part of the ocular surface. Optionally, when the at least one light sensor comprises the IR light sensors, in such a case, the plurality of light emitters would comprise at least two IR light emitters. The IR light sensors are employed to sense an intensity of IR light that is incident upon these light sensors upon being reflected off an ocular surface of the user's eye and to determine a direction from which the IR light is incident upon these infrared light sensors. Optionally, when the at least one light sensor comprises visible-light sensors, the plurality of light emitters would comprise at least two visible-light emitters. The visible light sensors are employed to sense an intensity of visible light that is incident upon these light sensors upon being reflected off an ocular surface of the user's eye and to determine a direction from which the visible light is incident upon these visible light sensors. All the aforesaid types of light sensors are well-known in the art. A technical effect of all the aforementioned types of light sensors is that they enable the gaze-tracking system to work efficiently under various lighting conditions and to track the user's gaze with high accuracy and precision.

Optionally, the backlight of the display module is implemented as an array of miniature light emitting diodes (LEDs), each miniature LED in the array having a diameter in a range of 10 micrometers to 200 micrometers. Beneficially, the array of miniature LEDs is significantly smaller than conventional LEDs, allowing for a denser arrangement of LEDs across a light-emitting plane of the backlight and providing a uniform illumination of the display. The array of miniature LEDs encompass at least micro-LEDs and/or mini-LEDs. A diameter of the miniature LED may, for example, lie in a range from 10, 11, 12, 14, 17, 20, 25, 30, 40, 50, 70, 90, 120 or 140 micrometers up to 25, 35, 60, 90, 110, 150, 180 or 200 micrometers. A technical effect of implementing the backlight unit as the array of miniature LEDs is that it simplifies the integration of the plurality of light emitters within the predefined region of the active area and does not interfere with the primary function of the display.

Optionally, when the display is the LCD comprising at least one polariser, and the predefined region is a backlight of the display module, the at least one polariser has one or more openings corresponding to an arrangement of the plurality of light emitters in the backlight. A technical benefit of this is that the one or more openings facilitate the light emitted by the plurality of light emitters to pass through the at least one polariser in order to incident towards the user's eyes for gaze-tracking purposes. In other words, an optical path of the light emitted by the plurality of light emitters would not be obstructed due to the presence of the one or more openings, and the light could easily travel towards the user's eyes without affecting any functionality of the at least one polariser. This enables highly accurate gaze tracking whilst allowing for a compact design of the display module (and the display apparatus also), as compared to the prior art. This also ensures minimal optical interference and an efficient transmission of the light from the plurality of light emitters. The term “polariser” refers to an optical component that filters light waves to allow only those oscillating in a specific direction to pass through. It will be appreciated that a given opening is precisely designed to allow the light to pass through while maintaining the primary functionality of the at least one polariser.

Optionally, when the display is the LCD comprising at least one colour filter array, and the predefined region is a backlight of the display module, the at least one colour filter array excludes one or more colour filters corresponding to an arrangement of the plurality of light emitters in the backlight. A technical benefit of this is that an exclusion of the one or more colour filters facilitate(s) the light emitted by the plurality of light emitters to pass through the at least one colour filter array (CFA) in order to incident towards the user's eyes for gaze-tracking purposes. In other words, an optical path of the light emitted by the plurality of light emitters would not be obstructed due to the presence of colour filters in the at least one CFA, and the light could easily travel towards the user's eyes without affecting any functionality of the at least one CFA. This enables highly accurate gaze tracking whilst allowing for a compact design of the display module (and the display apparatus also), as compared to the prior art. Herein, the term “colour filter array” refers to an arrangement of colour filters in front of a plurality of pixels of the LCD in a manner that each pixel of the LCD is covered by a colour filter (for example, a red colour filter, a green colour filter, a blue colour filter, or similar) that allows only a certain wavelength of light (corresponding to a colour of the colour filter) to pass therethrough. Examples of the CFA may include but are not limited to, a Bayer CFA, an X-Trans CFA, a Tetracell CFA, and a Nonacell CFA. The aforesaid types of CFAs are well-known in the art. It will be appreciated that the exclusion of the one or more colour filters may be accomplished by selectively removing or leaving out the one or more colour filters in specific regions where the plurality of light emitters are positioned within the backlight. This process may involve designing the at least one CFA such that areas corresponding to positions of the plurality of light emitters are left unfiltered/unobstructed, allowing the emitted light to pass through. A technical effect of this is that it ensures minimal optical interference and an efficient transmission of the light from the plurality of light emitters, enhancing the performance of the gaze-tracking system while maintaining the compactness and functionality of the display apparatus.

Optionally, when the display is the LCD comprising a thin-film transistor (TFT) array, and the predefined region is a backlight of the display module, one or more transistors corresponding to an arrangement of the plurality of light emitters in the backlight, are one of: removed from the TFT array, physically re-adjusted within the TFT array. A technical benefit of this is that a removal or a physical re-adjustment of the one or more transistors facilitate(s) the light emitted by the plurality of light emitters to pass through the TFT array in order to incident towards the user's eyes for gaze-tracking purposes. In other words, an optical path of the light emitted by the plurality of light emitters would not be obstructed due to the removal or the physical re-adjustment of the one or more transistors, and thus, the light could easily travel towards the user's eyes, without affecting any functionality of the TFT array. This enables highly accurate gaze tracking whilst allowing for a compact design of the display module (and the display apparatus also), as compared to the prior art.

It will be appreciated that when the LCD comprises the TFT array, certain regions of the TFT array align with the positions of the plurality of light emitters in the backlight. In these regions, the removal of the one or more transistors could be achieved by either physically disconnecting the one or more transistors from the TFT array or eliminating corresponding transistor elements through a manufacturing process. Further, the physical re-adjustment involves relocating the one or more transistors to other areas of the TFT array where they do not interfere with the positions of the plurality of light emitters in the backlight. The term “thin-film transistor array” refers to a matrix of transistors formed on a substrate, and used in the LCD. Each transistor in the array is a semiconductor device that controls the flow of electrical current to individual pixels or segments of the LCD. The one or more transistors are fabricated using thin layers of semiconductor materials, for example, such as amorphous silicon, metal oxide, or similar, and are arranged in a grid pattern.

Optionally, when the display is the LED-based display, the plurality of light emitters are arranged in place of a set of LEDs of the LED-based display. In this regard, instead of using a standard, complete set of LEDs in the LED-based display, some of the LEDs in the LED-based display can be replaced with the plurality of light emitters. Such a process could involve modifying a manufacturing process to replace or modify the layout of the LEDs in the LED-based display. It will be appreciated that the set of LEDs (that are to be replaced by the plurality of light emitters) constitutes only a small portion of an entirety of LEDs of the LED-based display. Optionally, the set of LEDs comprises a plurality of LEDs arranged in at least one of: an inactive region of the LED-based display, an occluded region of the LED-based display that would be invisible to a user of the display apparatus, a peripheral region of the LED-based display. A technical benefit of replacing the set of LEDs with the plurality of light emitters is that it facilitates the light emitted by the plurality of light emitters to incident towards the user's eyes for gaze-tracking purposes without any obstruction. This enables highly accurate gaze tracking whilst allowing for a compact design of the display module (and the display apparatus also), as compared to the prior art.

Optionally, the display apparatus further comprises an optical element arranged on an optical path between the display and an eye of the user, wherein the optical element defines an effective active area of the display module and the at least one of: the inactive region, the occluded region, the peripheral region, of the display, within the active area of the display module. In this regard, the term “optical element” refers to a component that is capable of at least manipulating an optical path of the light. Such a manipulation could be done by way of at least one of: reflection, refraction, diffraction. The optical element may be employed to achieve effects, such as focusing the light, redirecting the light, modifying an optical path of the light, and the like. Examples of the optical element may include, but are not limited to, a lens, a beam splitter, a polariser, and a diffuser. The term “effective active area” refers to a portion of the active area that is functionally visible to the user, as defined by the optical element. Notably, the active area of the display module encompasses the effective active area of the display module.

By knowing how the optical element would be arranged on the optical path and a field of view of the optical element, it is possible to accurately determine which region of the display would be visible to the user and which region of the display would be invisible to the user. The region of the display which would be invisible to the user is the occluded region of the display. It will be appreciated that this arrangement is particularly beneficial in applications for example, such as augmented reality, gaze tracking, and similar, where precise control over visible regions is essential for aligning virtual objects with real-world views or tracking the user's line of sight (namely, the user's gaze) with high accuracy. It will also be appreciated that a use of the optical element to define the effective active area and other optional regions of the display facilitates arranging the plurality of light emitters accordingly and may also improve the efficiency of the display module by reducing power consumption in areas that are not actively utilised for displaying images to the user, for example, such as the inactive region, the occluded region, the peripheral region, of the display module.

Optionally, the display apparatus further comprises a processor configured to:
control the gaze-tracking system such that the plurality of light emitters emit light towards an eye of a user, and the at least one light sensor captures sensor data pertaining to reflections of the emitted light from an ocular surface of the eye;
determine a gaze direction of the eye, based at least on the sensor data.

Herein, the processor controls the overall operation of the gaze-tracking system, the processor being communicably coupled to the gaze-tracking system. It will be appreciated that the sensor data captured by the at least one light sensor depends on the type of the at least one light sensor. Optionally, when the at least one light sensor is implemented as a camera, the sensor data comprises images of the eye of the user, wherein said images represent at least the reflections of the emitted light from the ocular surface of the eye.

It will be appreciated that the processor determines the gaze direction of the user's eye by analysing the sensor data. When the sensor data comprises the images of the eye, said images represent at least one glint or reflection point, the processor identifies the at least one glint by processing the images, and compares their positions to other features of the eye, such as a pupil or an iris of the eye. Based on known positions of the plurality of light emitters and a geometry of the eye, the processor is optionally configured to apply a mathematical model (such as a ray-tracing algorithm or corneal reflection mapping) to determine how the eye is oriented in space. For example, if glints are equidistant from the pupil center, the eye is likely gazing straight ahead in a field of view of the user. If the pupil shifts to one side relative to the glints, the gaze direction corresponds to a direction of said shift. Glint-based gaze tracking is well-known in the art.

Optionally, the display apparatus is an extended-reality (XR) device, and wherein the processor is further configured to:
control generation of XR images, based on the gaze direction of the eye; and
control the display module to display the XR images.

In this regard, the term “extended-reality device” refers to a device that is capable of displaying XR images to a user. Optionally, when controlling the generation of the XR images, the processor is configured to generate the XR images itself. Alternatively, optionally, when controlling the generation of the XR images, the processor is configured to send information indicative of the gaze direction of the eye to an external processor that is configured to generate the XR images based on said information. The processor sends the generated XR images to the display module for rendering, ensuring that the display module presents the XR images in real time and synchronizes them with the gaze direction of the user for a responsive and immersive visual experience. It will also be appreciated that real-time synchronization of generation of the XR images with the gaze direction of the user improves immersion, reduces motion-to-photon latency, enhances usability, and similar, especially in applications such as gaming, training simulations, remote collaboration, and the like. A technical effect of the aforementioned feature is that it enables real-time, gaze-directed rendering of the XR images. The generation of XR images is well-known in the art.

The present disclosure also relates to the method as described above. Various embodiments and variants disclosed above, with respect to the aforementioned first aspect, apply mutatis mutandis to the method.

Optionally, in the method, the predefined region of the active area of the display module is at least one of: an inactive region of the display, an occluded region of the display that would be invisible to a user of the display apparatus, a peripheral region of the display, a backlight of the display module.

Optionally, when the display is a liquid crystal display (LCD), the method further comprises at least one of:
creating one or more openings in at least one polariser of the LCD, corresponding to an arrangement of the plurality of light emitters in a backlight of the display module;
removing one or more colour filters in at least one colour filter array, corresponding to an arrangement of the plurality of light emitters in a backlight of the display module;
removing or physically re-adjusting one or more transistors in a thin-film transistor (TFT) array, corresponding to an arrangement of the plurality of light emitters in a backlight of the display module.

Optionally, in the method, when the display is a light emitting diode (LED)-based display, the method further comprises replacing a set of LEDs of the LED-based display, with the plurality of light emitters.

### DETAILED DESCRIPTION OF THE DRAWINGS

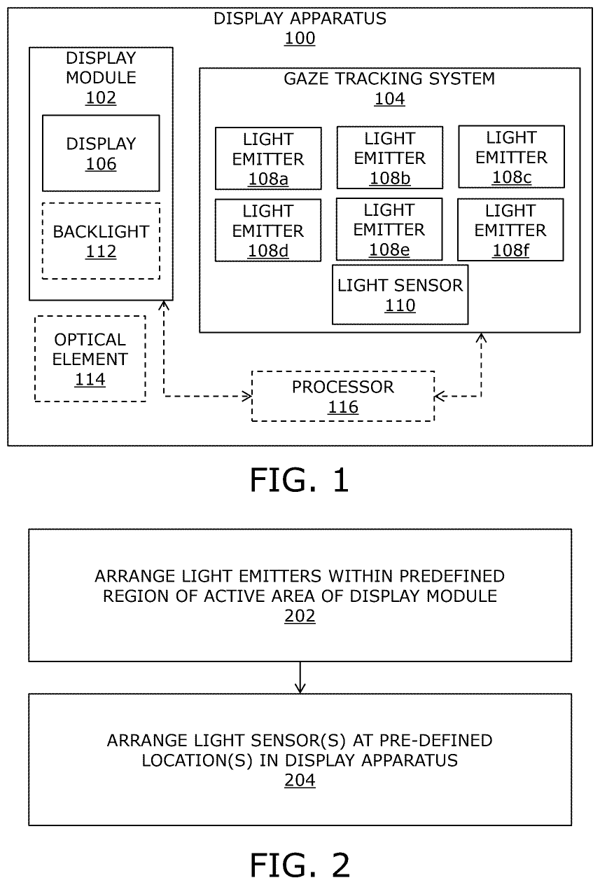

Referring to FIG. 1, illustrated is a block diagram of an architecture of a display apparatus 100, in accordance with an embodiment of the present disclosure. The display apparatus 100 comprises a display module 102 and a gaze-tracking system 104, wherein the display module 102 comprises a display 106. The gaze-tracking system 104 comprises a plurality of light emitters (for example, depicted as light emitters 108a, 108b, 108c, 108d, 108e, and 108f) and at least one light sensor (for example, depicted as a light sensor 110). Optionally, the display module 102 further comprises a backlight 112. Optionally, the display apparatus 100 further comprises an optical element 114 and a processor 116. The processor 116 is communicably coupled to the gaze tracking system 104 and the display module 102.

It may be understood by a person skilled in the art that the FIG. 1 includes a simplified architecture of the display apparatus 100 for the sake of clarity, which should not unduly limit the scope of the claims herein. The person skilled in the art will recognize many variations, alternatives, and modifications of embodiments of the present disclosure.

Referring to FIG. 2, illustrated are steps of a method for integrating a gaze-tracking system into a display apparatus comprising a display module in accordance with an embodiment of the present disclosure. At step 202, a plurality of light emitters of the gaze-tracking system are arranged within a predefined region of an active area of the display module, wherein the display module comprises a display. At step 204, at least one light sensor of the gaze-tracking system is arranged at one or more pre-defined locations in the display apparatus.

The aforementioned steps are only illustrative and other alternatives can also be provided where one or more steps are added, one or more steps are removed, or one or more steps are provided in a different sequence without departing from the scope of the claims herein.

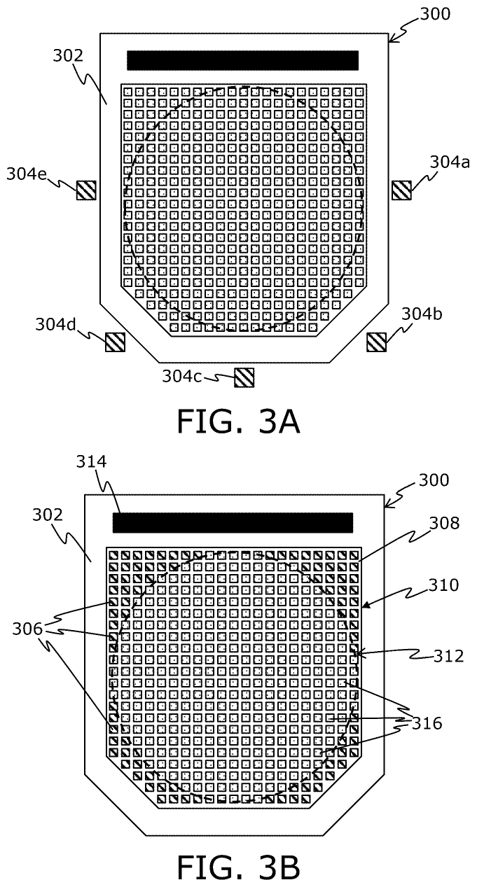

Referring to FIG. 3A, illustrated is a conventional arrangement of a plurality of light emitters (for example, depicted as light emitters 304a, 304b, 304c, 304d, and 304e, shown using diagonal lines pattern) of a gaze-tracking system with respect to a display module 300. It is to be noted that FIG. 3A depicts a prior art case. Herein, the display module 300 comprises a display 302, wherein the plurality of light emitters 304a-e are arranged around (namely, outside) the display module 300 as physically separate components. Since the plurality of light emitters 304a-e are physically separate components, each light emitter is individually arranged around the display module 300 during an assembly process. Such an arrangement complicates the assembly process and also results in a bulky design of the display module 300. Moreover, even slight misalignments of any of the plurality of light emitters 304a-e can degrade an accuracy of gaze-tracking.

Referring to FIGS. 3B and 3C, there are shown exemplary arrangements of a plurality light emitters 306 (depicted using diagonal lines pattern) with respect to the display module 300, in accordance with an embodiment of the present disclosure. With reference to FIGS. 3B and 3C, the display module 300 comprises the display 302, wherein the plurality of light emitters 306 are arranged within a predefined region 308 of an active area 310 of the display module 300. Optionally, the display module 300 comprises an effective active area 312 (depicted using a dashed circle) within the active area 310. Notably, the active area 310 encompasses the predefined region 308 (within which the plurality of light emitters 306 are arranged) and the effective active area 312 (that is actually utilised for displaying images). Optionally, the display module 300 comprises a driver integrated circuit 314 that manages an electrical control signal required to operate the display 302.

It will be appreciated that arranging the plurality of light emitters 306 in the aforesaid manner beneficially enables in a compact design of the display module 300 without complicating an assembly process, as compared to the prior art as shown earlier with reference to FIG. 3A.

With reference to FIG. 3B, the display 302 is a light-emitting diode (LED)-based display, wherein the plurality of light emitters 306 are arranged in place of a set of LEDs of the LED-based display. Optionally, the display 302 comprises a plurality of LEDs 316 (for example, depicted using dotted patterns) in the effective active area 312. For sake of convenience, only three LEDs have been marked. With reference to FIG. 3C, the display 302 is a liquid crystal display (LCD), wherein the light emitters 306 are arranged in the predefined region 308 of the active area 310 of the display module 300.

FIGS. 3A-C are merely examples, which should not unduly limit the scope of the claims herein. A person skilled in the art will recognize many variations, alternatives, and modifications of embodiments of the present disclosure.

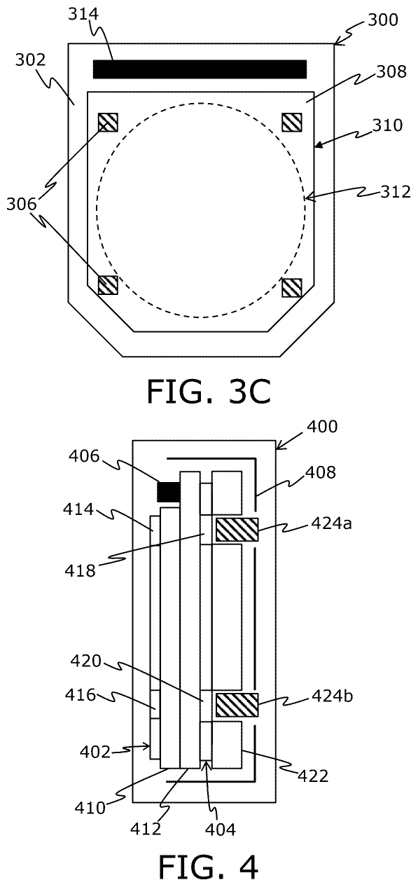

Referring to FIG. 4, illustrated is an exemplary arrangement of a plurality of light emitters (for example, depicted as light emitters 424a and 424b using diagonal lines pattern, for sake of simplicity and clarity) in a backlight 422 with respect to a liquid crystal display (LCD) 400 comprising at least one polariser (depicted as a first polariser 402 and a second polariser 404), in accordance with an embodiment of the present disclosure.

In this regard, there is shown a side view of the LCD 400, wherein the LCD 400 comprises the first polariser 402, the second polariser 404, a driver integrated circuit 406, a bezel 408, a first glass 410 and a second glass 412. Herein, the first glass 410 is arranged between the first polariser 402 and the bezel 408, the second glass 412 is arranged between the second polariser 404 and the driver integrated circuit 406. Herein, the first polariser 402 comprises two openings 414 and 416, while the second polariser 404 comprises two opening 418 and 420. The openings 414, 416, 418, and 420 are hollow openings. The openings 414 and 418 are aligned to correspond to an arrangement of the light emitter 424a in the backlight 422 such that light emitted by the light emitter 424a can incident towards an eye of a user for gaze-tracking purposes, without any obstruction. Similarly, the openings 416 and 420 are aligned to correspond to an arrangement of the light emitter 424b in the backlight 422 such that light emitted by the light emitter 424b can incident towards an eye of a user for gaze-tracking purposes, without any obstruction.

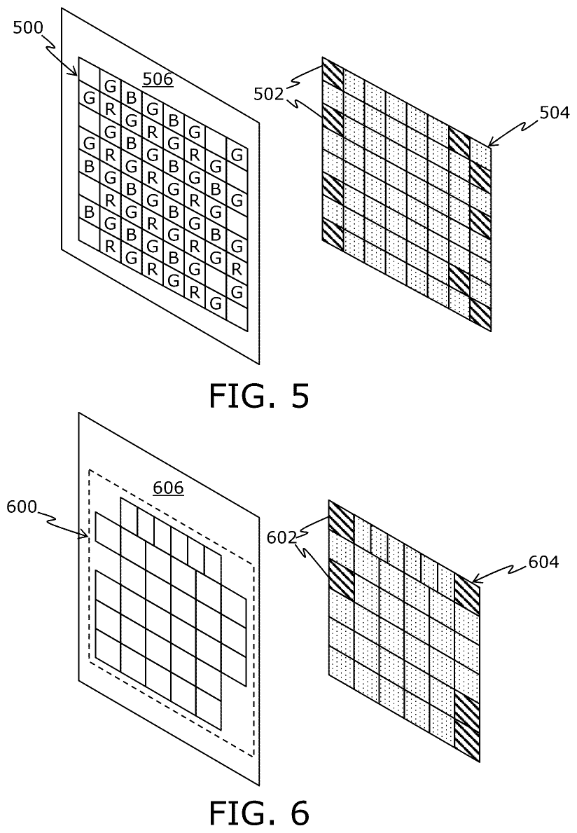

Referring to FIG. 5, illustrated is an exemplary arrangement of a plurality of light emitters 502 (for example, depicted using a diagonal line pattern) in a backlight 504 with respect to a liquid crystal display 506 comprising a colour filter array 500, in accordance with an embodiment of the present disclosure. Herein, for sake of clarity and simplicity, the colour filter array 500 is shown as a 8×8 array of colour filters, wherein “B” refers to a blue colour filters, “G” refers to a green colour filter, and “R” refers to a red colour filter. As shown, the colour filter array 500 excludes 9 colour filters (depicted as empty white spaces in the colour filter array 500) corresponding to the arrangement of the plurality of light emitters 502 in the backlight 504 such that light emitted by the plurality of light emitter 502 can incident towards an eye of a user for gaze-tracking purposes, without any obstruction.

Referring to FIG. 6, illustrated is an exemplary arrangement of a plurality of light emitters 602 (for example, depicted using a diagonal line pattern) in a backlight 604 with respect to a liquid crystal display 606 comprising a thin-film transistor array 600, in accordance with an embodiment of the present disclosure. Herein, one or more transistors corresponding to the arrangement of the plurality of light emitters 602 in the backlight 604, are shown to be one of: removed from the TFT array 600, physically re-adjusted within the TFT array 600. This enables light emitted by the plurality of light emitter 602 to incident towards an eye of a user for gaze-tracking purposes, without any obstruction. In an example, for sake of simplicity and clarity, a 6×6 TFT array 600 is shown, wherein six transistors in a first row are physically re-adjusted. Similarly, in a third row, a fifth row, and a sixth row of the 6×6 TFT array 600, one transistor from each of these rows is shown to be removed (depicted as white empty spaces in the 6×6 TFT array 600).

FIGS. 4, 5, and 6 are merely examples, which should not unduly limit the scope of the claims herein. A person skilled in the art will recognize many variations, alternatives, and modifications of embodiments of the present disclosure.

1. A display apparatus comprising:
a display module comprising a display; and
a gaze-tracking system comprising a plurality of light emitters and at least one light sensor, wherein the plurality of light emitters are arranged within a predefined region of an active area of the display module.

2. The display apparatus of claim 1, wherein the predefined region of the active area of the display module is at least one of: an inactive region of the display, an occluded region of the display that would be invisible to a user of the display apparatus, a peripheral region of the display, an entirety of the display, a backlight of the display module.

3. The display apparatus of claim 2, further comprising an optical element arranged on an optical path between the display and an eye of the user, wherein the optical element defines an effective active area of the display module and the at least one of: the inactive region, the occluded region, the peripheral region, of the display, within the active area of the display module.

4. The display apparatus of claim 2, wherein the backlight of the display module is implemented as an array of miniature light emitting diodes (LEDs), each miniature LED in the array having a diameter in a range of 10 micrometers to 200 micrometers.

5. The display apparatus of claim 1, wherein the display is one of: a liquid crystal display (LCD), a light emitting diode (LED)-based display.

6. The display apparatus of claim 5, wherein when the display is the LCD comprising at least one polariser, and the predefined region is a backlight of the display module, the at least one polariser has one or more openings corresponding to an arrangement of the plurality of light emitters in the backlight.

7. The display apparatus of claim 5, wherein when the display is the LCD comprising at least one colour filter array, and the predefined region is a backlight of the display module, the at least one colour filter array excludes one or more colour filters corresponding to an arrangement of the plurality of light emitters in the backlight.

8. The display apparatus of claim 5, wherein when the display is the LCD comprising a thin-film transistor (TFT) array, and the predefined region is a backlight of the display module, one or more transistors corresponding to an arrangement of the plurality of light emitters in the backlight, are one of: removed from the TFT array, physically re-adjusted within the TFT array.

9. The display apparatus of claim 5, wherein when the display is the LED-based display, the plurality of light emitters are arranged in place of a set of LEDs of the LED-based display.

10. The display apparatus of claim 1, wherein light emitted by the plurality of light emitters is incident within an angular range of 0 degrees to 45 degrees relative to a surface normal of an eye of a user, when the display apparatus is in use.

11. The display apparatus of claim 1, wherein the at least one light sensor comprises at least one of: an infrared camera, a visible light camera, a multispectral camera, light field sensors, infrared light sensors, visible-light sensors.

12. The display apparatus of claim 1, wherein the plurality of light emitters comprise at least two of: an infrared light emitter, a visible light emitter.

13. The display apparatus of claim 1, further comprising a processor configured to:
control the gaze-tracking system such that the plurality of light emitters emit light towards an eye of a user, and the at least one light sensor captures sensor data pertaining to reflections of the emitted light from an ocular surface of the eye;
determine a gaze direction of the eye, based at least on the sensor data.

14. The display apparatus of claim 13, wherein the display apparatus is an extended-reality (XR) device, and wherein the processor is further configured to:
control generation of XR images, based on the gaze direction of the eye; and
control the display module to display the XR images.

15. A method for integrating a gaze-tracking system into a display apparatus comprising a display module, the method comprising:
arranging a plurality of light emitters of the gaze-tracking system within a predefined region of an active area of the display module, the display module comprising a display, and
arranging at least one light sensor of the gaze-tracking system at one or more pre-defined locations in the display apparatus.

16. The method of claim 15, wherein the predefined region of the active area of the display module is at least one of: an inactive region of the display, an occluded region of the display that would be invisible to a user of the display apparatus, a peripheral region of the display, a backlight of the display module.

17. The method of claim 15, wherein when the display is a liquid crystal display (LCD), the method further comprises at least one of:
creating one or more openings in at least one polariser of the LCD, corresponding to an arrangement of the plurality of light emitters in a backlight of the display module;
removing one or more colour filters in at least one colour filter array, corresponding to an arrangement of the plurality of light emitters in a backlight of the display module;
removing or physically re-adjusting one or more transistors in a thin-film transistor (TFT) array, corresponding to an arrangement of the plurality of light emitters in a backlight of the display module.

18. The method of claim 15, wherein when the display is a light emitting diode (LED)-based display, the method further comprises replacing a set of LEDs of the LED-based display, with the plurality of light emitters.
